(19) United States
(12) Patent Application Publication
(10) Pub. No.: US 2009/0046707 A1
(43) Pub. Date: Feb. 19, 2009

(54) Apparatus for enhanced information display in end user devices of a packet-based communication network

(76) Inventors: Daniel T. Smires, Freehold, NJ (US); Mary Grikas, Colts Neck, NJ (US); Deepak Ottur, Hillsborough, NJ (US)

Correspondence Address: VONAGE, 23 MAIN STREET, HOLMDEL, NJ, 07733, US

(21) Appl. No.: 12/214,221

(22) Filed: Jun. 16, 2008

Related U.S. Application Data
(60) Provisional application No. 60/934,650, filed on Jun. 15, 2007.

(51) Int. Cl. H04L 12/66

(52) U.S. Cl. 370/352

(57) ABSTRACT

Method and apparatus for information conveyance in an end user device of a packet-based communication service where the end user device is connected to a PSTN-based communication device includes detecting a power up condition of the end user device connected to the PSTN-based communication device, detecting a packet-based network connection, retrieving an end user profile from the packet-based communication service attempting a communication registration operation and displaying one or more non-binary type messages at the end user device regarding the status of the communication service. The apparatus for enhanced information conveyance includes a main body having a local area packet network connection means, a wide area packet network connection means and a non-packet network connection means for connection of a PSTN-based communication device and a display panel body adapted to display information regarding the status of the communication service in a non-binary manner.

### CROSS-REFERENCE TO RELATED APPLICATIONS

This application claims priority to U.S. Provisional Patent Application Ser. No. 60/934,650, filed Jun. 15, 2007, which is incorporated by reference herein in its entirety.

### FIELD OF THE INVENTION

The present disclosure relates generally to systems and methods for provisioning and maintaining a network communications device. In particular, the present disclosure relates to devices and methods for providing enhanced information to Voice-over-IP (VoIP) subscribers.

### BACKGROUND

In just a short time, VoIP has revolutionized the availability of affordable and advanced high-quality audio and visual communications. As VoIP has grown more popular, the size and complexity of service provider networks has increased immensely to handle the increased call volume and various service enhancements made possible by VoIP. As service (and/or equipment) provider networks grow, the task of provisioning service and maintaining it for a large customer base presents technological, logistical, and business challenges.

One example of prior art architecture for the remote (user or subscriber) end of a VoIP service provider network typically includes a connection device connected between a PSTN-based communication device (i.e. a typical telephone) and a packet-based network by which the VoIP service provider affects communication services. The connection device translates between analog signals required for the PSTN-based communication device and digital signals transmitted over the network. In some examples, the connection device is a stand-alone, dedicated device. In other examples, the connection device includes a wired or wireless router that accepts an incoming high speed packet network connection as input and provides one or more output ports for relaying such network signals to suitable end user equipment such as a computer and additional outputs for connection to a PSTN-based telephone. In each example, device status and other such network information is conveyed only by binary means. That is, typical the status information is conveyed by use of a few lights flashing on/off (i.e., LEDs) with minimal or technically descriptive abbreviations provided therebelow that only technically savvy individuals can interpret or understand. In some instances, there may be no markings at all.

Typically, when a communication failure occurs, (e.g., component failure, improper connection to the network or a power source, poor network traffic conditions and the like), extensive assistance must be provided to the end user by service personnel to diagnose the cause of the communication failure. These service personnel working remotely (e.g., over the phone, via an online “chat” session and the like) encounter difficulties when trying to properly diagnose the technical issues based on the performance issues as described by an end user (including which lights may or may not be illuminated on the communication device). In the frequent case that these symptoms or descriptions are incomplete or inaccurate, time and other resources are wasted in attempting to provide a solution to the problem.

Additionally, traditional communication devices are usually manufactured in ordinary rectangular shapes which are generally unappealing and lack a flair for design or visual impact. Accordingly, such existing-shaped communication devices are placed or otherwise installed underneath home office furniture, on the floor or otherwise generally out of sight so as to reduce clutter and undesirable visual appeal. As a result it is difficult to access the communication device to read the device status indicators and not generally possible to successfully display supplementary information to the user/subscriber that may be desirable. In view of at least these two factors, there is a lack of information, understanding and aesthetics that greatly reduces the potential enjoyment of the overall broadband telephone experience.

Accordingly, there is a need in industry for technological solutions to improve and simplify end user experience in the setup, use and further exploitation of connection devices, especially those used for VoIP, and VoIP services.

### SUMMARY OF THE INVENTION

The present invention generally relates to a method and apparatus for information conveyance in an end user device of a packet-based communication service where the end user device is connected to a PSTN-based communication device. The method includes the steps of detecting a power up condition of the end user device connected to the PSTN-based communication device, detecting a packet-based network connection, retrieving an end user profile from the packet-based communication service attempting a communication registration operation and displaying one or more non-binary type messages at the end user device regarding the status of the communication service. The end user profile contains IP configuration information and the registration operation may be performed via SIP. The one or more messages for display is provided in the end user profile or delivered via a SIP NOTIFY message.

The apparatus for enhanced information conveyance includes a main body having at least one local area packet network connection means, at least one wide area packet network connection means and at least one non-packet network connection means for connection of a PSTN-based communication device and a display panel body adapted to display information regarding the status of the communication service in a non-binary manner. The display panel adaptation may be a display screen, one or more function buttons and a combination of such elements. The apparatus may have articulation means between the main body and display panel body for providing freedom of movement therebetween. The articulation means may be a hinge assembly, a set of telescoping members, a gimbal assembly and wireless means. In a preferred embodiment, the main body and the display panel body and integral with each other. The display panel body enhanced information conveyance means is responsive to communication service status messages from the packet-based communication service and those status messages are selected from messages included in the end user profile and messages provided by SIP messaging. Additionally, the display panel body enhanced information conveyance means is responsive to user-based requests to the packet-based communication service and such requests are selected from changing system features or apparatus settings associated with the end user device, reviewing call logs associated with the end user device, reviewing a status of user communication channels and inquiring about general system information.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, wherein:

FIGS. 1A and 1B illustrate a first embodiment of a communication device for enhanced information display in accordance with the subject invention;

FIGS. 2A and 2B illustrate a second embodiment of a communication device for enhanced information display in accordance with the subject invention;

FIG. 3 illustrates detailed view of a means for conveying enhanced information in accordance with the subject invention.

FIG. 4 illustrates a third embodiment of a communication device for enhanced information display in accordance with the subject invention;

FIGS. 5A-I illustrate a flowchart of display messages and enhanced information available to the user of the communication service based on various menu selections;

FIG. 6 illustrates a schematic diagram of a controller that can be used to practice the subject invention;

FIG. 7 illustrates a schematic diagram of a software architecture that can be used to practice the subject invention; and

FIGS. 8A-8B illustrates a flowchart of display messages and enhanced information available to the user of the communication service based on registration status of the communication device.

### DETAILED DESCRIPTION

One aspect of the present disclosure includes an apparatus for communicating a status of a communications device in a packet-based communication network and/or the packet-based communication network itself in a non-binary manner. In one embodiment of the invention, the packet-based communication network is a VoIP network that establishes voice communication sessions according to the Session Initiation Protocol (SIP). Session Initiation Protocol (SIP) is used to establish subscriber calls (into or out of the packed-based network and within the packet-based network to another subscriber). It was developed by the Internet Engineering Task Force (IETF) and published in 2002 as RFC 3261 which is herein incorporated by reference. SIP messages are exchanged between a VoIP service provider (via one or more database and proxy servers) and one or more end users (via a network terminal adapter (TA)) to establish the communication session. However, in instances where the communication session cannot be established, the subject invention includes means for providing enhanced information (i.e., beyond blinking lights) to facilitate troubleshooting the cause of the uninitiated session. Such means is also capable of displaying information regarding installation of the communication device and enhanced features as described in greater detail below.

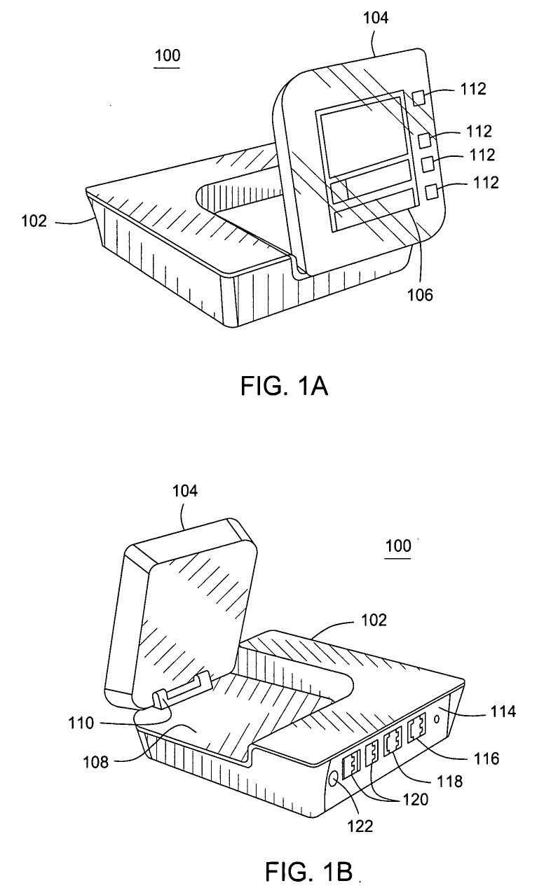

FIGS. 1A and 1B illustrate a first embodiment of the invention as “single port” communication device 100. More specifically, FIG. 1A illustrates a front % perspective view and FIG. 1B illustrates a rear ¾ perspective view respectively of the communication device 100. Accordingly, the reader is directed to FIGS. 1A and 1B simultaneously in the following description. The phrase “single port” is defined as having one output port for connecting packet-based network devices.

In detail, the communication device 100 includes a main body 102 and a display panel body 104. The main body 102 further includes a recessed portion 108 into which the display panel body 104 can either be retracted into or extended away from. The retraction and extension movements are achievable by way of one or more articulation means 110. In one embodiment of the invention, the articulation means 110 is a hinge assembly where each of the main body 102 and display panel body 104 include a hinge member which are capable of rotation about a common axis or pin. In a second embodiment (not shown) the articulation means 110 includes a hinge assembly with one or more telescoping members on either the main body 102, the display panel body 104 or both to facilitate hinging and vertical movement. Such embodiment may also include one or more telescoping members as described to facilitate hinging and horizontal movement. In a third embodiment (not shown), the articulation means 110 includes a gimbal assembly to facilitate angular movement of the display panel body 104 with respect to the main body 102.

The articulation means need not be exclusively a physical means. In a fourth embodiment of the invention, the articulation means 110 includes wireless capability components disposed in the main body 102 and display panel 104 body. In this manner, the display panel body 104 can be removed from the recessed portion 108 of the main body 102 and brought to a remote location from the main body 102 for increased viewing by the user without having to obtain and install additional wires, cables, power cords and extensions thereof to place the communication device 100 in an advantageous location. In one example of the fourth embodiment, the wireless capability components operate according to the Institute of Electrical and Electronics Engineers (IEEE) standard 802.11, also known as WiFi networking protocol. Examples of the WiFi protocol include but are not limited to 802.11a, b and g and are herein incorporated in their entirety by reference. Other wireless networking protocols known to those skilled in the art are also within the scope of the invention. Such an embodiment may also have plural removable display panel bodies associated with a single main body to improve coverage of the enhanced information. Alternately, there may be a plurality of main bodies associated with the same user account for displaying custom status information based on a user profile or other such configuration.

Disposed within the display panel body 104 is a plurality of enhanced information components to facilitate dissemination of enhanced status information about the communication device and/or supplemental information to enhance user/subscriber enjoyment of the communication service. Specifically, and in one embodiment, the plurality of enhanced information components includes a display screen 106 and one or more function buttons 112 disposed proximate the display screen 106.

The main body 102 further includes a rear panel 114. The rear panel 114 provides provisions for various connections to network and power devices for operation of the communication device 100. Particularly, the rear panel 114 has a first port 116 for connection to a local area network device (also known as a LAN port) and a second port 118 for connection to a wide area network (also known as a WAN port) such as the Internet. The rear panel 114 also includes at least one PSTN-style connection port 120 (also known as an FsX port) for connecting at least one PSTN-style device to the communication device 100. Additionally, a power port 122 is provided to allow for connection of a power source to the communication device 100.

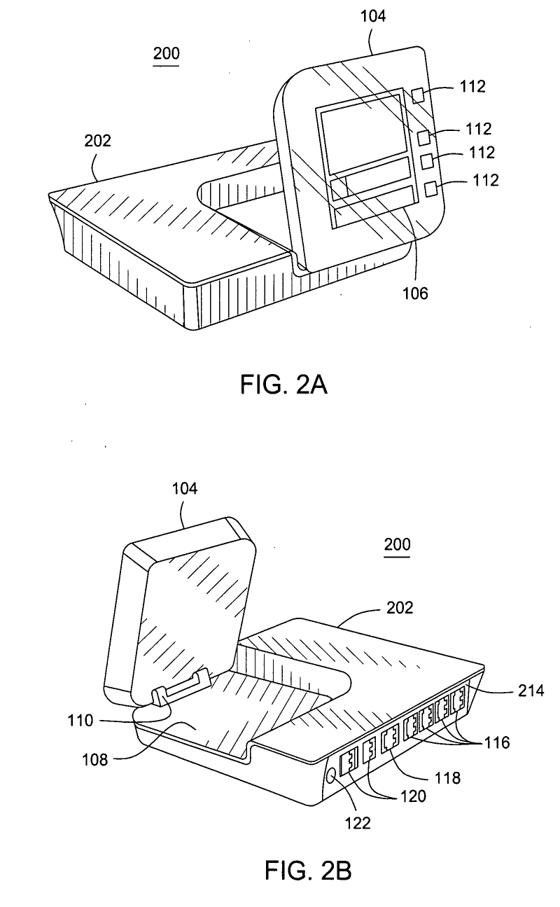

FIGS. 2A and 2B illustrate a second embodiment of the invention as “multi-port” communication device 200. More specifically, FIG. 2A illustrates a front % perspective view and FIG. 2B illustrates a rear ¾ perspective view respectively of the communication device 200. Accordingly, the reader is directed to FIGS. 2A and 2B simultaneously in the following description. The phrase “multi-port” is defined as having more than one output port for connecting packet-based network devices.

In detail, the communication device 200 includes an elongate main body 202 and a display panel body 104. The elongate main body 202 is identical in form, function and features as the main body 102 of the first described embodiment 100 with the following differences. First, the elongate main body 202 is longer than main body 102 to accommodate additional hardware and LAN ports. Specifically, the elongate main body 202 includes an elongate rear panel 214 that has a plurality of first ports 116 for connections to local area network devices (also known as a LAN ports). Other connection ports are as disclosed above with respect to the first described embodiment 100. Additionally, the communication device 200 also includes a recessed portion 108 and articulation means 110 for extension, retraction and movement of the display panel body 104 as disclosed above with respect to the first described embodiment 100. The display panel body 104 is identical in form, function and features as the display panel body 104 of the first described embodiment 100.

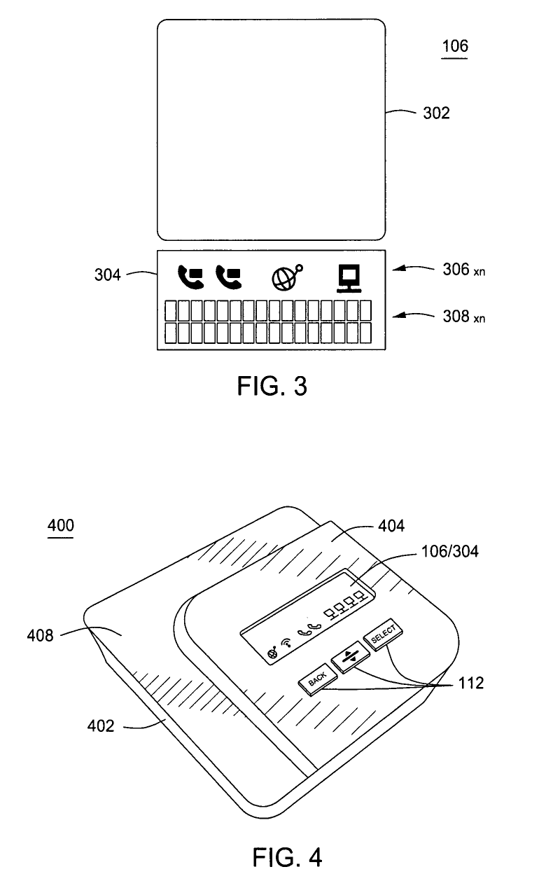

FIG. 3 illustrates a close up of the display screen 106. Specifically, the display screen 106 includes a graphic display 302 and an iconic/character display 304. The graphic display 302 is suitable for and provisioned to display information graphically (i.e., photos, stylized lettering and images in general). The iconic/character display 304 includes a plurality of icons 306n for the dedicated and repeatable display of frequently encountered information (i.e., which line is in use, connection status and the like). Additionally, the iconic/character display 304 includes a plurality of text segment fields 308n for the dedicated display of textually driven information. In a preferred embodiment of the invention, the connection device includes one graphic display, six (6) icons and two lines of 16 segment character fields. Other variations of the display screen are possible based on the anticipated messaging size and type of display method desired.

FIG. 4 illustrates a third embodiment of the invention as another “single port” communication device 400. More specifically, FIG. 4 illustrates a front 34 perspective view. For sake of clarity, a rear ¾ perspective view is not specifically shown, but is indicated as being identical in form and function to the rear % perspective view of the communication device 100 of FIG. 1B and the description of such embodiment provided earlier.

In detail, the communication device 400 includes a main body 402 having a display panel portion 404. The display panel portion 404 can either be contoured to be raised above or recessed below a top surface 408 of the main body 402. Alternately, the display panel portion 404 can be flush with the top surface 408.

Disposed within the display panel portion 404 is a plurality of enhanced information components to facilitate dissemination of enhanced status information about the communication device 400 and/or supplemental information to enhance user/subscriber enjoyment of the communication service. Specifically, and in one embodiment, the plurality of enhanced information components includes a display screen 106 and one or more function buttons 112 disposed proximate the display screen 106. In this particular embodiment, no graphic display is provided and only an iconic/character display 304 is provided. Iconic information is optionally displayed in a text-based manner. Although the arrangement, number and/or assigned functionality of the buttons 112 may differ from one depicted embodiment to another, this in no way changes the scope or intent of the subject invention. For example, the buttons 112 need not be physical buttons on the main body or display portion body of the device and can be “soft” buttons using touch screen technology for the display screen 106. Additionally, functionality of the buttons are shown as an “UP” arrow, a “DOWN” arrow, a “BACK” button (for returning to the previous screen) and a “SELECT” button (for choosing a feature on a currently displayed screen); however, other buttons or functionality are possible.

Various disclosed embodiments advantageously enable the conveyance of device status information through enhanced visual display. Categories of device status conditions include, but are not limited to, device actions in progress, successful actions, failed actions, device errors, software errors, firmware errors, network errors, and system errors.

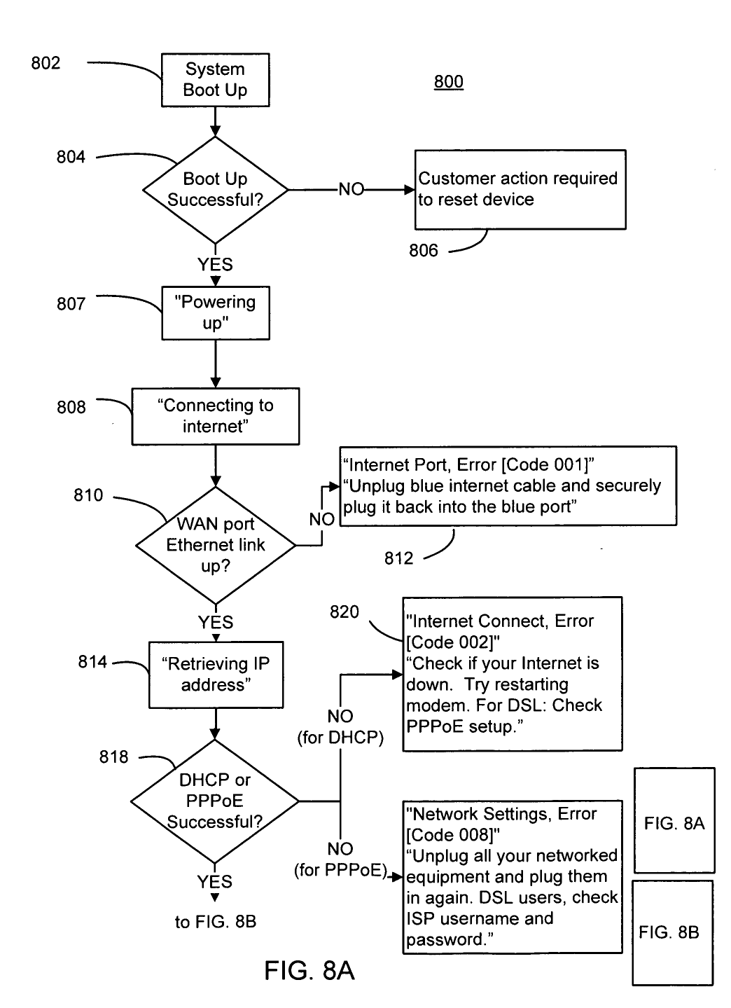

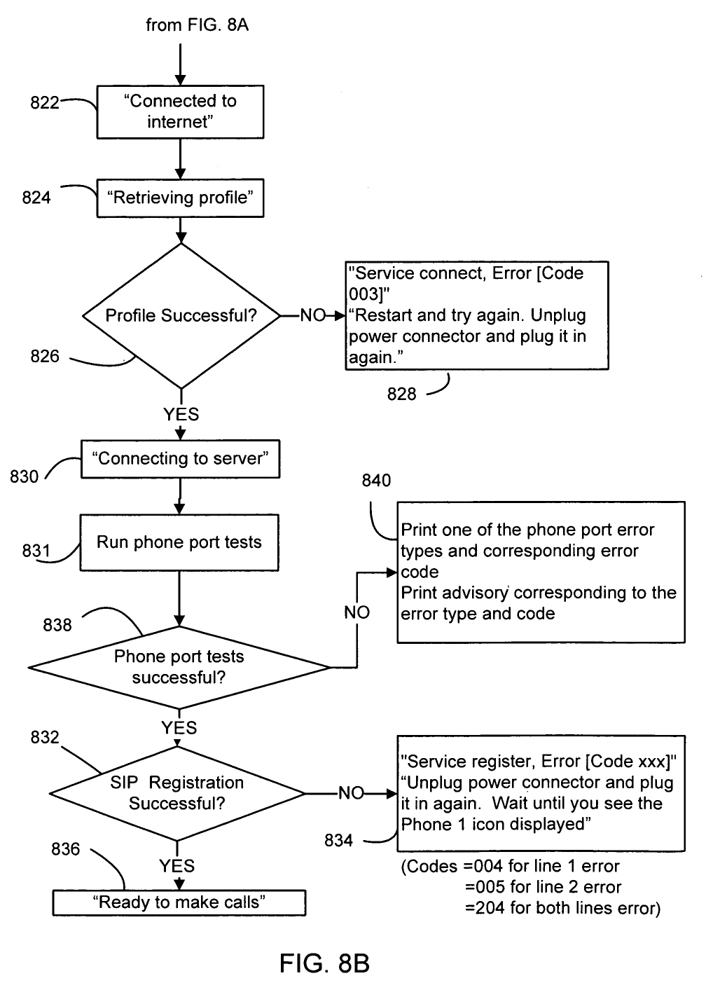

The flowchart of FIG. 8 depicts a series of steps 800 that coincide with various conditions that the communication device 100/200/400 will fall under during operation. Depending on how the various decisions steps are answered during operation, messages indicating the status of the communication device will be displayed. For example, the series of steps begins with a boot up step 802 whereby a communication device initialization occurs.

At step 804, a decision is made as to whether the boot up step 802 was successful. If so, the next step is to display a message indicating that the communication device is powering up 807. An exemplary message for step 807 is “Powering up”. If the power up is not successful, a customer action step 806 must occur to restart the process 800. An exemplary customer action for step 806 is to unplug a communication device power connector and plug it in again.

After the communication device has displayed the power up message 807, the next step is to display a message indicating that a connection to the internet (or other wide area network) is performed 808. An exemplary message for step 808 is “Connecting to Internet”.

At step 810, a decision is made as to whether a Wide Area Network port link was successful or not. If so, the next step is to display a message indicating that an Internet Protocol address retrieval is being attempted 814. An exemplary message for step 814 is “Retrieving IP address”. If the Wide Area Network port link was not successful, a failure message is displayed at step 812. An exemplary message for step 812 is displayed in FIG. 8A.

At step 818, a decision is made as to whether the IP addressing was successful or not. In one embodiment of the invention, IP addressing is performed by DHCP (Dynamic Host Configuration Protocol) which is a communications protocol that lets network administrators centrally manage and automate the assignment of Internet Protocol (IP) addresses in an organization's network. In an alternate embodiment, IP addressing is performed via Point-to-Point Protocol over Ethernet (PPPOE) which is a network protocol for encapsulating Point-to-Point Protocol (PPP) frames inside Ethernet frames. If the addressing is successful, the next step(s) is(are) to display a message(s) indicating that there is a connection to the Wide Area Network (Internet) 822 and that a customer or device profile retrieval is being attempted 824. Exemplary messages for steps 822 and 824 are seen in FIG. 8B. If the addressing is not successful, the next step is to display a message indicating that there is no connection to the Wide Area Network (Internet) 820. Depending on which IP addressing protocol was used, a corresponding exemplary message is shown in FIG. 8A at step 820.

At step 826, a decision is made as to whether the profile retrieval was successful or not. If the profile retrieval is successful, the next step is to display a message indicating that there is an attempt to connect to a server associated with the communication service 830. An exemplary message for step 830 is “Connecting to Server”. If the profile retrieval is not successful, the next step is to display a message indicating that there was a failed connection 828. An exemplary message for step 828 is shown in FIG. 8B

After server connection message(s) are displayed, the process 800 continues to step 831 where one or more tests are performed on the ports of the communication device.

At step 838, a decision is made as to whether the phone port test(s) were successful or not. If the test(s) were successful, the process 800 continues to step 832 as described below. If the test(s) were not successful, the next step is to display a message(s) indicating that there was a failed test at one or more ports 840. An exemplary message for step 840 is shown in FIG. 8B.

At step 832, a decision is made as to whether connection and registration to the communication server was successful or not. If the registration is successful, the next step is to display a message indicating that the communication service is available 836. An exemplary message for step 836 is “Ready to Make Calls”. If the retrieval is not successful, the next step is to display a message indicating that there was a failed connection 834. An exemplary message for step 834 is shown in FIG. 8B.

Table 1 illustrates various error condition codes that correspond to various errors that occur during operation of the communication device 100/200/400. Upon an error condition being set, the corresponding code (i.e., a three digit number) is displayed along with one or more plain language error messages as shown in the second column of Table 1. Although the plain language error messages are shown in English, foreign languages selected from the group consisting of French and Spanish are alternately displayable. The third column of Table 1 provides an explanation of the error condition and what status the communication device may be in as a result of the error. The fourth column of Table 1 provides optional audible messages that are played via an Interactive Voice Recording (IVR) system when a user attempts to start a communication session and one of the error conditions exists. In one embodiment of the invention, the error code # and error name are displayed on a first display line and troubleshooting tips or corrective actions are displayed on a second display line of a display screen such as that identified above. Note that not every error condition will have an audible message. Although 6 distinct errors codes are provided along with a message and explanation for each such error, Table 1 is in no way limiting or the sole possible error codes used to account for error conditions. Similarly, the error messages and explanations are exemplary in nature and may be exchanged or revised to suit display, processor or device constraints without affecting the scope of the content. Other errors and message can additionally be added as necessary to account for changing device and/or network conditions.

TABLE 1

| Error | Message | | |
|---|---|---|---|
| Code | Position on LCD | Message (In English) | Message Description |
| 001 | Line 1 Initial Display | Internet Port | Internet (WAN) Link Error |
| | Line 1 Second Display | Error [Code 001] | Customer will see this message when their |
| | Line 2 Display | Unplug blue cable and | device is powered up and ready to connect |
| | (message scrolls) | securely plug it back into the | to the Internet but their WAN (Internet) port |
| | | blue port | Is down |
| 002 | Line 1 Initial Display | Internet Connect | Internet (WAN) DHCP Error |
| | Line 1 Second Display | Error [Code 002] | Customer will see this message when their |
| | Line 2 Display | Check if your Internet is | device is properly connected but is unable |
| | (message scrolls) | down. Try restarting modem. | to retrieve an IP address from the device it |
| | | For DSL: Check PPPoE | is connected to. |
| | | setup. | |
| 003 | Line 1 Initial Display | “VoIP service” Connect | Configuration Server (provisioning) Error |
| | Line 1 Second Display | Error [Code 003] | Customer will see this message when their |
| | Line 2 Display | Restart and try again. Unplug | device is properly set up but cannot |
| | (message scrolls) | power connector and plug it | connect to the Service Network. |
| | | in again. | Error 003 will come if the device has |
| | | | successfully got an IP address but it is |
| | | | unable to contact Serivce servers. |
| 004 | Line 1 Initial Display | “VoIP service” Register | Line 1 Registration Failed |
| | Line 1 Second Display | Error [Code 004] | Customer will see this message when their |
| | Line 2 Display | Unplug power connector and | device is properly set up, can connect to |
| | (message scrolls) | plug it in again. Wait until you | the “VoIP service” Network, but cannot |
| | | see the Phone 1 icon | register to the Service SIP proxy. |
| | | displayed. | |
| 005 | Line 1 Initial Display | “VoIP service” Register | Line 2 Registration FailedCustomer will |
| | Line 1 Second Display | Error [Code 005] | see this message when their device is |
| | Line 2 Display | Unplug power connector and | properly set up, can connect to the Service |
| | (message scrolls) | plug it in again. Wait until you | Network, but cannot register to the Service |
| | | see the Phone 2 icon | SIP proxy. (Device does not get a 200OK) |
| | | displayed. | |
| 006 | Line 1 Initial Display | “VoIP service” Activate | Device has not been activated. |
| | Line 1 Second Display | Error [Code 006] | Customer will see this message if they |
| | Line 2 Display | If you bought your device at a | bought their device in a Retail store and |
| | (message scrolls) | store, visit the “VoIP service” | have not activated it on the “VoIP service” |
| | | website to sign up for “VoIP | website. (They will see this message if |
| | | service”. Otherwise, wait a | BOTH phone lines have not been |
| | | few minutes until you see the | activated.) |
| | | Phone icon displayed. | Customers will also see this message if |
| | | | the device IS activated (i.e., provisioned) |
| | | | but is unable to get its first profile. |
| 007 | Line 1 Initial Display | Phone Port Line | Customer will see this message when their |
| | Line 1 Second Display | Error [Code 007] | telephone is plugged into a phone port on |
| | Line 2 Display | Phone may be plugged into | the “VoIP service” device that is not set up |
| | (message scrolls) | incorrect green port. Try other | for service and that phone goes OFF |
| | | green port. | HOOK. |
| 008 | Line 1 Initial Display | Network Settings | Customer will see this message when their |
| | Line 1 Second Display | Error [Code 008] | device is connected but there are incorrect |
| | Line 2 Display | Unplug all your networked | network settings. |
| | (message scrolls) | equipment and plug them in | |
| | | again. DSL users, check ISP | |
| | | username and password. | |
| 011 | Line 1 Initial Display | High Voltage 1 | Hazardous Potential Test failed. |
| | Line 1 Second Display | Error [Code 011] | Hazardous AC or DC voltage is present on |
| | Line 2 Display | High voltage. Disconnect | either the tip, ring or both signals of phone |
| | (message scrolls) | cable from phone port 1 | port 1. |
| | | immediately. Contact “VoIP | |
| | | service” customer care. | |
| 012 | Line 1 Initial Display | High Voltage 2 | Hazardous Potential Test failed. |
| | Line 1 Second Display | Error [Code 012] | Hazardous AC or DC voltage is present on |
| | Line 2 Display | High voltage. Disconnect | either the tip, ring or both signals of phone |
| | (message scrolls) | cable from phone port 2 | port 2. |
| | | immediately. Contact “VoIP | |
| | | service” customer care. | |
| 013 | Line 1 Initial Display | Line 1 Wiring | Foreign Electro Motive Force (EMF) Test |
| | Line 1 Second Display | Error [Code 013] | failed. Foreign voltage is present on either |
| | Line 2 Display | Phone port 1 may be | the tip, ring or both signals of phone port |
| | (message scrolls) | connected to live telco line. | 1. The device has detected an additional |
| | | Plug phone directly to green | external voltage on the FXS (Phone) port |
| | | port 1. | of the unit. |
| 014 | Line 1 Initial Display | Line 2 Wiring | Foreign Electro Motive Force (EMF) Test |
| | Line 1 Second Display | Error [Code 014] | failed. Foreign voltage is present on either |
| | Line 2 Display | Phone port 2 may be | the tip, ring or both signals of a phone port. |
| | (message scrolls) | connected to live telco line. | “n” can be 1 or 2 and it indicates the |
| | | Plug phone directly to green | phone port. |
| | | port 2. | The device has detected an additional |
| | | | external voltage on the FXS (Phone) port |
| | | | of the unit. |
| 015 | Line 1 Initial Display | Short in Line 1 | Resistive Faults Test failed. Either the tip |
| | Line 1 Second Display | Error [Code 015] | or ring is shorted to ground or they are |
| | Line 2 Display | Faulty phone or home wiring. | shorted to each other. |
| | (message scrolls) | Plug known good phone | |
| | | using known good cable to | |
| | | green port 1. | |
| 016 | Line 1 Initial Display | Short in Line 2 | Resistive Faults Test failed. Either the tip |
| | Line 1 Second Display | Error [Code 016] | or ring is shorted to ground or they are |
| | Line 2 Display | Faulty phone or home wiring. | shorted to each other. |
| | (message scrolls) | Plug known good phone | |
| | | using known good cable to | |
| | | green port 2. | |
| 017 | Line 1 Initial Display | Line 1 Off Hook | Receiver Off-Hook Test failed. One or |
| | Line 1 Second Display | Error [Code 017] | more phones are off hook on phone port 1 |
| | Line 2 Display | Check that all phones | when the test is run. |
| | (message scrolls) | connected to green port 1 are | |
| | | on hook. | |
| 018 | Line 1 Initial Display | Line 2 Off Hook | Receiver Off-Hook Test failed. One or |
| | Line 1 Second Display | Error [Code 018] | more phones are off hook on phone port 2 |
| | Line 2 Display | Check that all phones | when the test is run. |
| | (message scrolls) | connected to green port 2 are | |
| | | on hook. | |
| 019 | Line 1 Initial Display | Line 1 Load | REN Test failed - High REN detected. Too |
| | Line 1 Second Display | Error [Code 019] | many parallel phones or a faulty phone is |
| | Line 2 Display | Too many phones or a faulty | connected to phone port 1. |
| | (message scrolls) | phone connected to green | |
| | | port 1. | |
| 020 | Line 1 Initial Display | Line 2 Load | REN Test failed - High REN detected. Too |
| | Line 1 Second Display | Error [Code 020] | many parallel phones or a faulty phone is |
| | Line 2 Display | Too many phones or a faulty | connected to phone port 2. |
| | (message scrolls) | phone connected to green | |
| | | port 2. | |
| 204 | Line 1 Initial Display | “VoIP service” Register | Customer will see this message when their |
| | Line 1 Second Display | Error[Code 204] | device is properly set up, can connect to |
| | Line 2 Display | Unplug power connector and | the “VoIP service” Network, but cannot |
| | (message scrolls) | plug it in again. Wait until you | register to the “VoIP service” SIP proxy. |
| | | see phone 1 and phone 2 | (Device does not get a 200OK) |
| | | icons displayed. | Note that this message will be displayed |
| | | | when we get the error on BOTH phone line |
| | | | 1 and phone line 2. Similar messages |
| | | | exist for the error occurring on a single |
| | | | phone line (refer to Error codes 004 and |
| | | | 005). |
| 211 | Line 1 Initial Display | High Voltage | Hazardous Potential Test failed. |
| | Line 1 Second Display | Error[Code 211] | Hazardous AC or DC voltage is present on |
| | Line 2 Display | High voltage. Disconnect | either the tip, ring or both signals of both |
| | (message scrolls) | cables from phone ports 1 | phone port 1 and phone port 2. |
| | | and 2 immediately. Contact | Note that this message will be displayed |
| | | “VoIP service” customer care. | when we get the error on BOTH phone line |
| | | | 1 and phone line 2. Similar messages exist |
| | | | for the error occurring on a single phone |
| | | | line (refer to Error codes 011 and 012). |
| 213 | Line 1 Initial Display | Line Wiring | Foreign Electro Motive Force (EMF) Test |
| | Line 1 Second Display | Error[Code 213] | failed. Foreign voltage is present on either |
| | Line 2 Display | Phone ports 1 and 2 may be | the tip, ring or both signals of phone port 1 |
| | (message scrolls) | connected to live telco lines. | and phone port 2. |
| | | Plug phones directly to green | The device has detected an additional |
| | | phone ports 1 and 2. | external voltage on the FXS (Phone) port |
| | | | of the unit. |
| | | | Note that this message will be displayed |
| | | | when we get the error on BOTH phone line |
| | | | 1 and phone line 2. Similar messages exist |
| | | | for the error occurring on a single phone |
| | | | line (refer to Error codes 013 and 014). |
| 215 | Line 1 Initial Display | Short in Lines | Resistive Faults Test failed. Either the tip |
| | Line 1 Second Display | Error[Code 215] | or ring is shorted to ground or they are |
| | Line 2 Display | Faulty phones or home | shorted to each other. |
| | (message scrolls) | wiring. Plug known good | Note that this message will be displayed |
| | | phones using known good | when we get the error on BOTH phone line |
| | | cables to green phone ports 1 | 1 and phone line 2. Similar messages exist |
| | | and 2. | for the error occurring on a single phone |
| | | | line (refer to Error codes 015 and 016). |
| 217 | Line 1 Initial Display | Lines Off Hook | Receiver Off-Hook Test failed. One or |
| | Line 1 Second Display | Error[Code 217] | more phones are off hook on phone port 1 |
| | Line 2 Display | Check that all phones | and phone port 2 when the test is run. |
| | (message scrolls) | connected to green phone | Note that this message will be displayed |
| | | ports 1 and 2 are on hook. | when we get the error on BOTH phone line |
| | | | 1 and phone line 2. Similar messages exist |
| | | | for the error occurring on a single phone |
| | | | line (refer to Error codes 017 and 018). |
| 219 | Line 1 Initial Display | Lines Load | REN Test failed - High REN detected. Too |
| | Line 1 Second Display | Error[Code 219] | many parallel phones or a faulty phone is |
| | Line 2 Display | Too many phones or faulty | connected to phone port 1 and phone port |
| | (message scrolls) | phones connected to green | 2. |
| | | phone ports 1 and 2. | Note that this message will be displayed |
| | | | when we get the error on BOTH phone line |
| | | | 1 and phone line 2. Similar messages exist |
| | | | for the error occurring on a single phone |
| | | | line (refer to Error codes 019 and 020). |

Table 2 illustrates various exemplary messages/information displayed on the display screen 106 based on enhanced features of the communication device 100/200/400 and comments for what information is displayed or available through such feature:

TABLE 2
Enhanced Information/Messages

| LCD Message Displayed | |
|---|---|
| or Functionality | Comments |
| Caller ID information | Display caller ID name and number, if available |
| | The caller-id will be displayed on the line that is |
| | called; optionally with a corresponding photo or |
| | logo identifying the caller. |
| Voicemail Message Waiting indication | An envelope icon on the LCD to indicate voicemail |
| | is waiting, #of waiting message, date and time. |
| Missed Call | Indicate the number of missed calls, i.e. “3 missed |
| | calls” |
| Number being dialed | |
| Call waiting information | Call waiting information is read from the device and |
| | should be one of the sub menu items |
| Phone on/off hook status | Display “Line n in use” where n is 1 or 2. Assuming |
| | the first line is for line 1, the second line is for line |
| | 2, “In use” on each line to indicate which line is in |
| | use. Also phone icon can be highlighted to indicate |
| | if it's in use. |
| Repeat dialing activated | Call feature setting can be read from device directly |
| | and should be as one of the sub-menu items |
| Click-2-Call in progress | The device shows if the call is initiated from a click- |
| | 2-call application. |
| International Call Block enabled | This information is provided in the device profile or |
| | a SIP NOTIFY message. |
| Caller ID block enabled | This is read from device and should be as one of |
| | the sub-menu items |
| Call Forwarding enabled | This information is provided in the device profile or |
| | a SIP NOTIFY message. |
| Do not disturb enabled | This information is provided in the device profile or |
| | a SIP NOTIFY message. |
| Set features on/off | Easy features that “toggle” on/off or enable/disable. |
| | Will eliminate the need for customer to login to |
| | account to set features on/off. For example, call |
| | waiting and international dialing. Could also |
| | provide the ability to disable call forwarding and |
| | voicemail via the device but not enable. |
| Incorporate capability to display a message from | |
| the provisioning profile at preset intervals | |
| Communication account information | If the account status is either Grace or |
| | Suspended, the device will display a message |
| | asking the customer to contact service |
| | provider for important account information |
| | (e.g., “We have an important message for |
| | you. Please log into your Web Account or call |
| | 1-xxx-xxx-xxxx.” (display the 800# for the |
| | Payment Processing team). |
| | The device will not display an indication that |
| | the account is in Grace or Suspended. |
| | Indication that Credit Card used for billing is |
| | about to expire - Note that the device will |
| | display a message asking the customer to |
| | contact service provider for important account |
| | information (e.g., “Please call 1-xxx-xxx-xxxx, |
| | we have an important message for you.” The |
| | 800# for the Payment Processing team will be |
| | displayed. |
| | The device will not display specific credit card |
| | information. |
| Service announcements | This information is provided in the device profile or |
| | a SIP NOTIFY message. |
| Informational announcements | Display when service has a new international rate, |
| | new feature, new payment method, etc. |
| Built in bandwidth test - display not only results of | Menu option |
| test but also codec being used | |
| Ability to adjust bandwidth from device | Just like bandwidth saver but no need to login to |
| | web account. |
| Display IP address | And perhaps other network information This can be |
| | implemented as a sub-menu item. |
| Phone port icon | Displays the following states: |
| | Registered (on) |
| | Not registered (off) |
| | Not provisioned (blinking) |
| WAN icon | Displays the following states: |
| | No physical |
| | IP address |
| | No IP address |
| | IP address but not connected to internet |
| | (Ping) perhaps a status message |
| Always show critical messages | Flash backlight |
| Hot key sequences for important items | Make it easier to scroll through menus; Even hot |
| | keys via the phone (DTMF) There are only a very |
| | limited key sequences can be defined for important |
| | tasks. DTMF from the phone can be implemented |
| | just like feature codes |
| 911 status | |
| Calendar | Display birthdays, Billing Date, Credit Card |
| | expiration date, etc. |
| Use SIP messages instead of profile for real time | |
| info | |
| Firmware version information | The firmware information can be read from device |
| | as a sub-menu item |
| Display numbers of minutes left/used for the | |
| month (for customers on minute plans) | |
| Brightness control | The up/down bottom can be used. |
| Ability to get the weather from the device | The device will initiate a URL fetch at specified zip |
| | code and just display the returned value. |
| Time display | |
| Alarm clock | Ring phone, use speaker The device needs to |
| | implement cron job like utilities to ring phone. And |
| | allow keypad inputs to set the alarm time. |

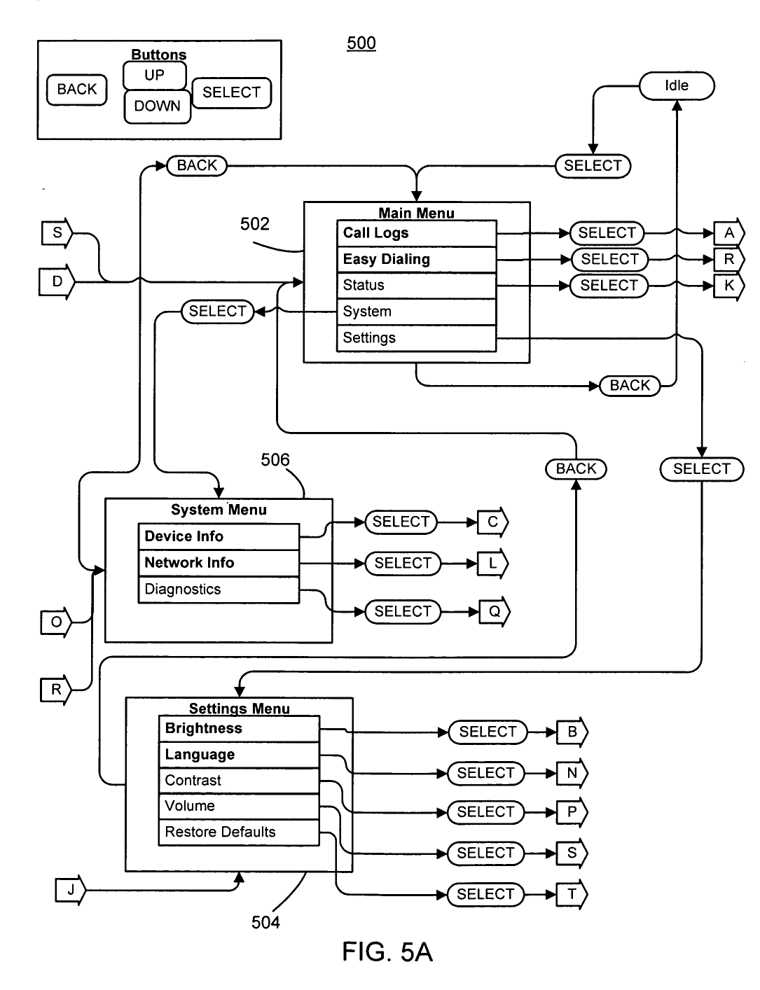

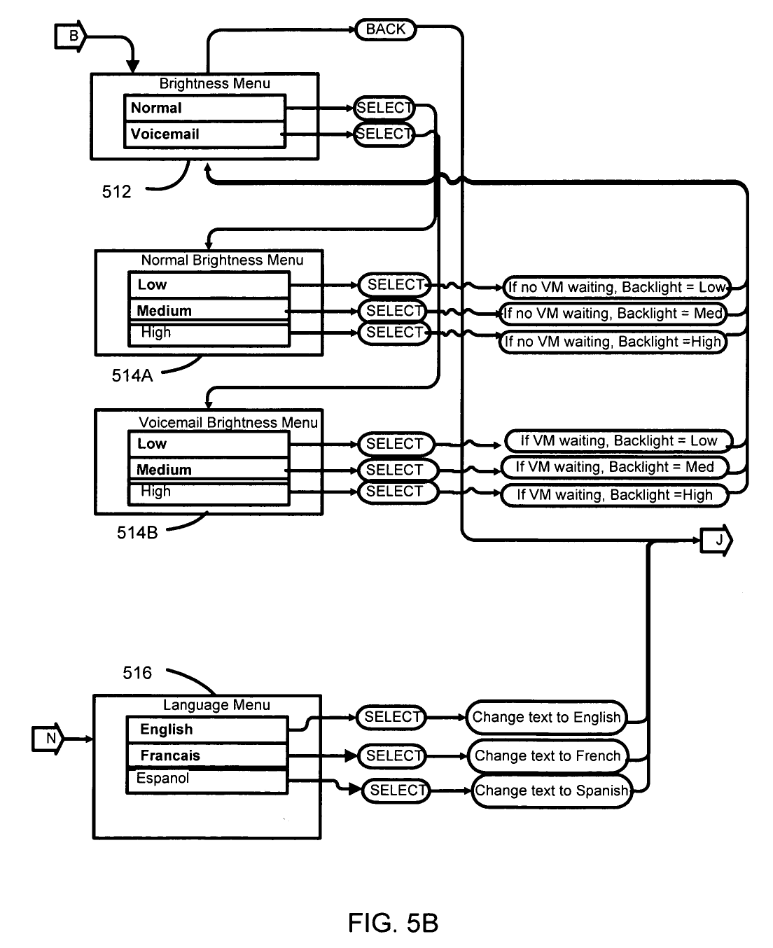

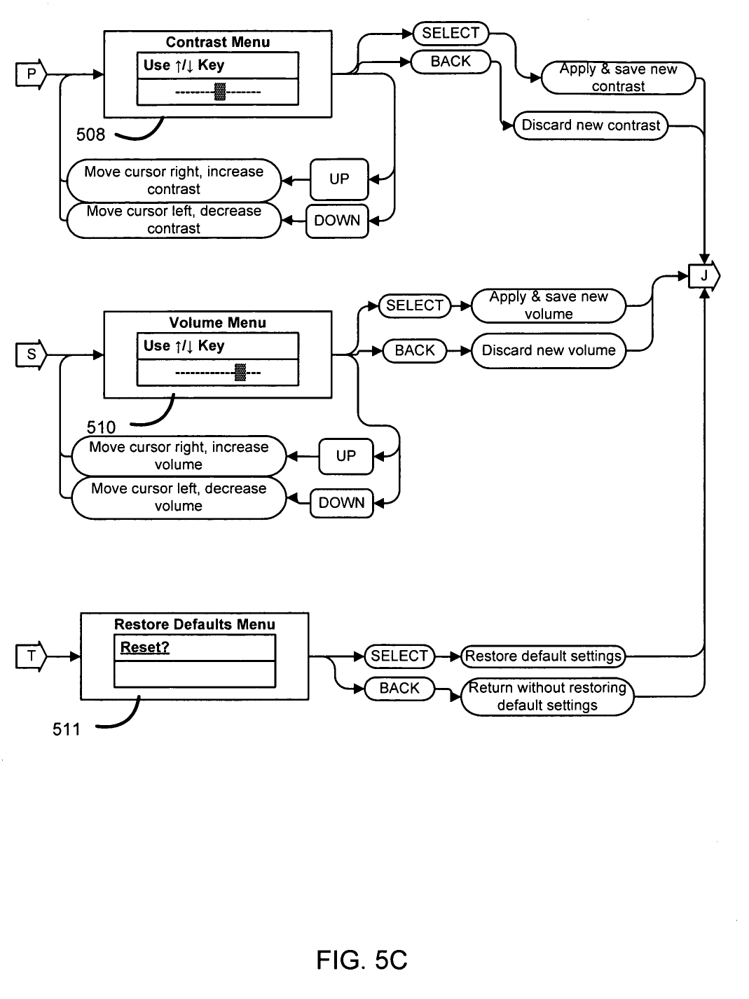

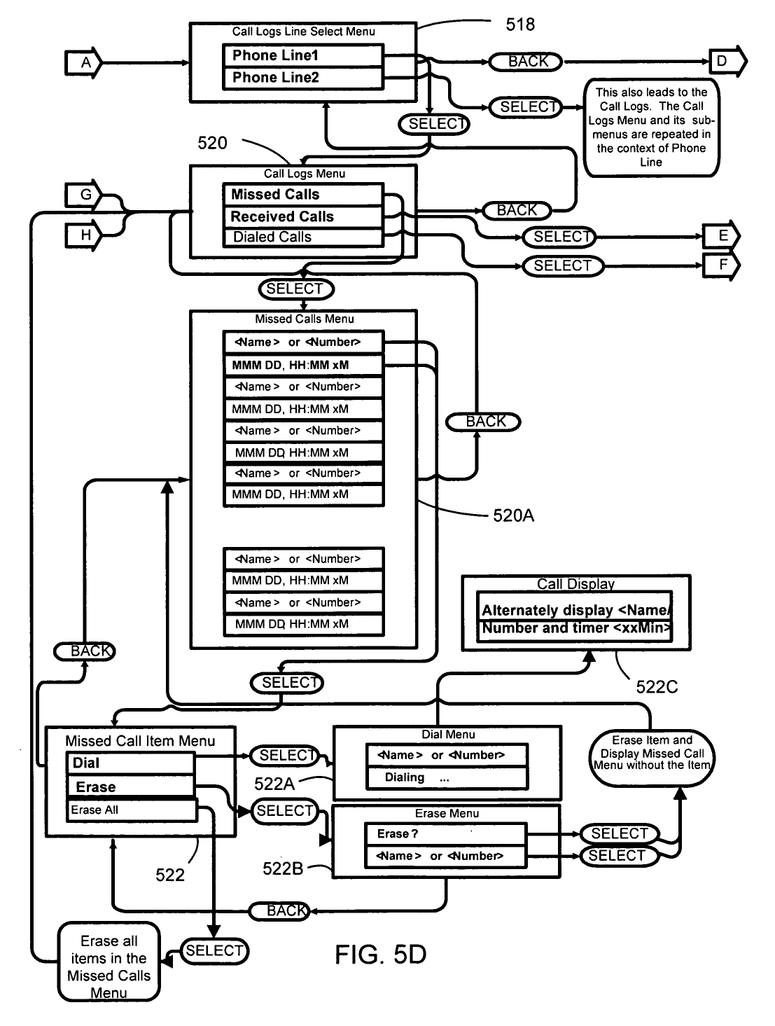

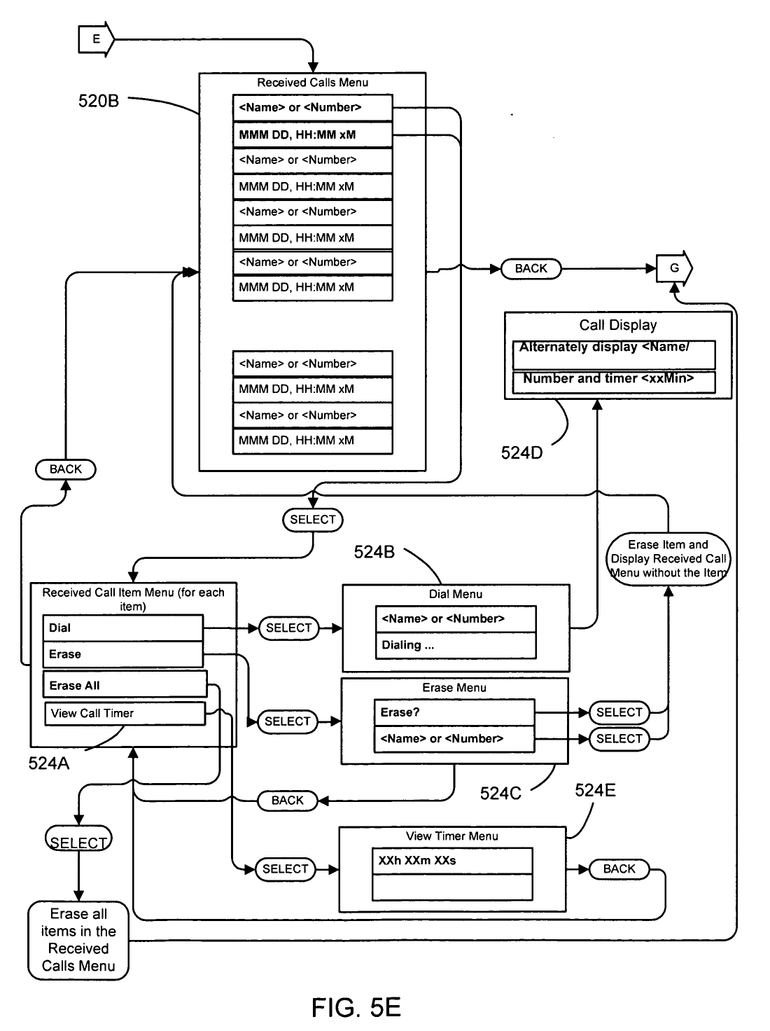

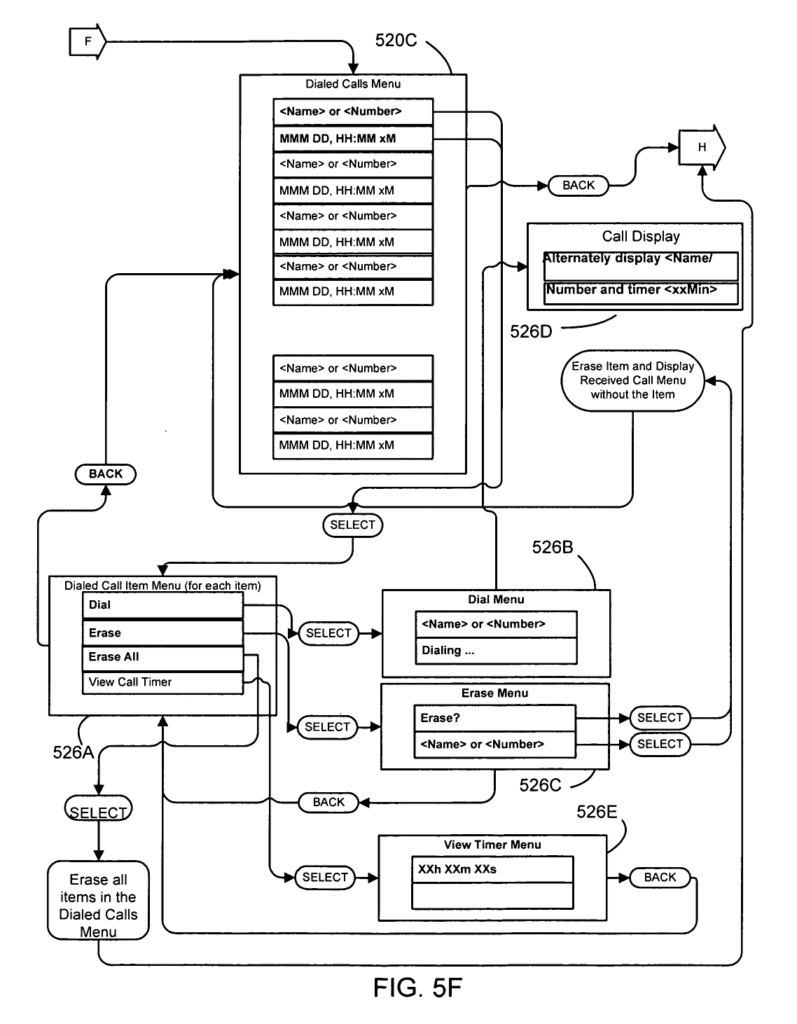

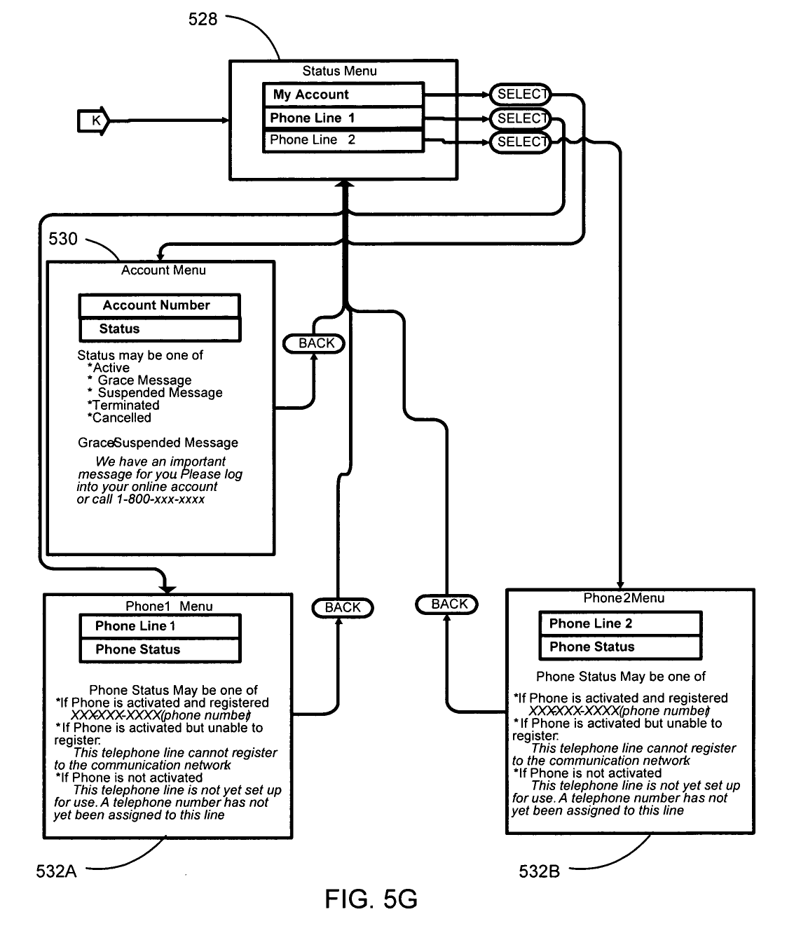

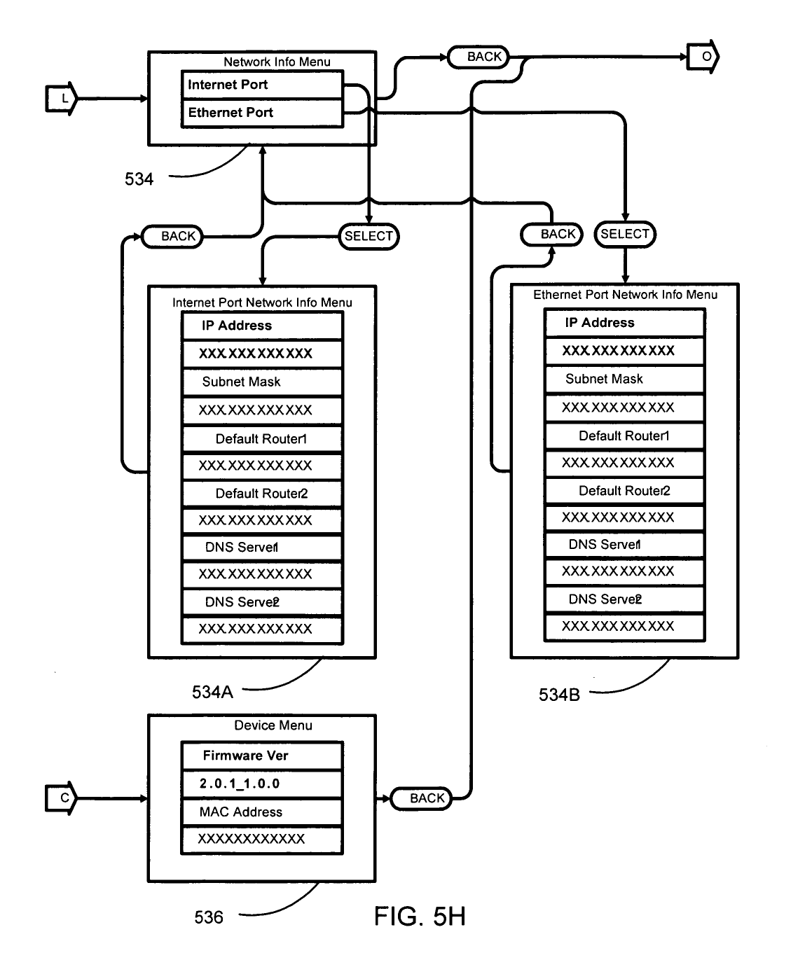

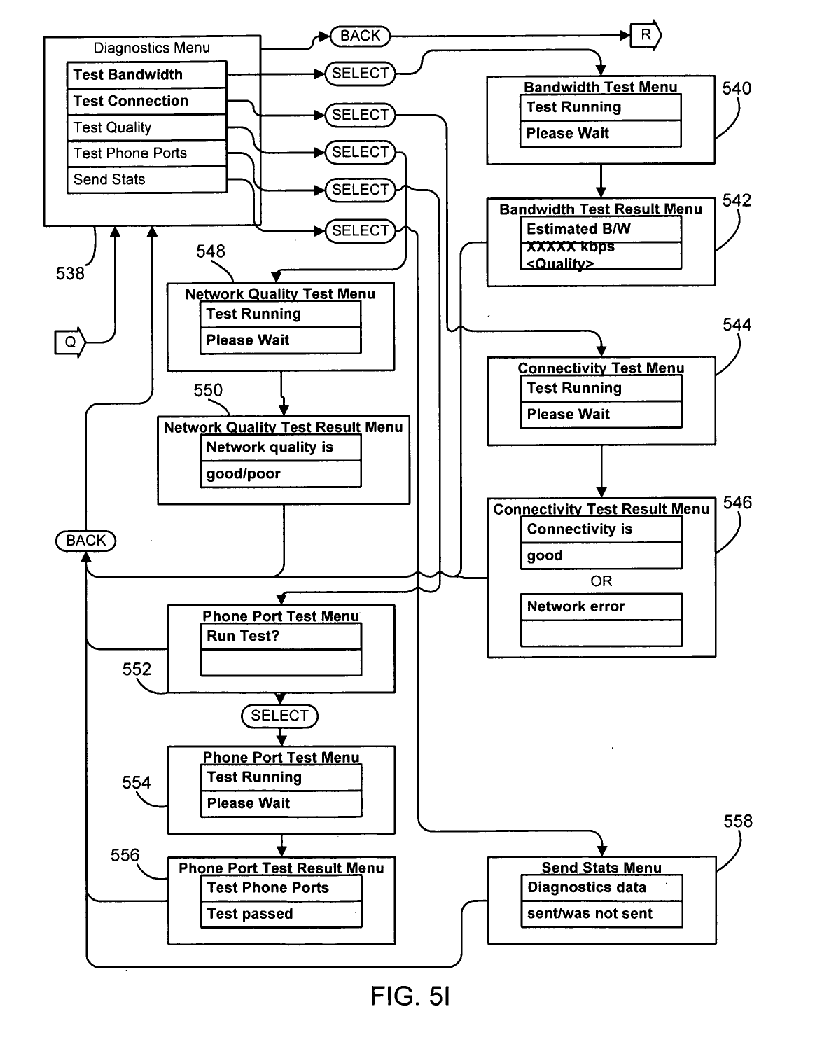

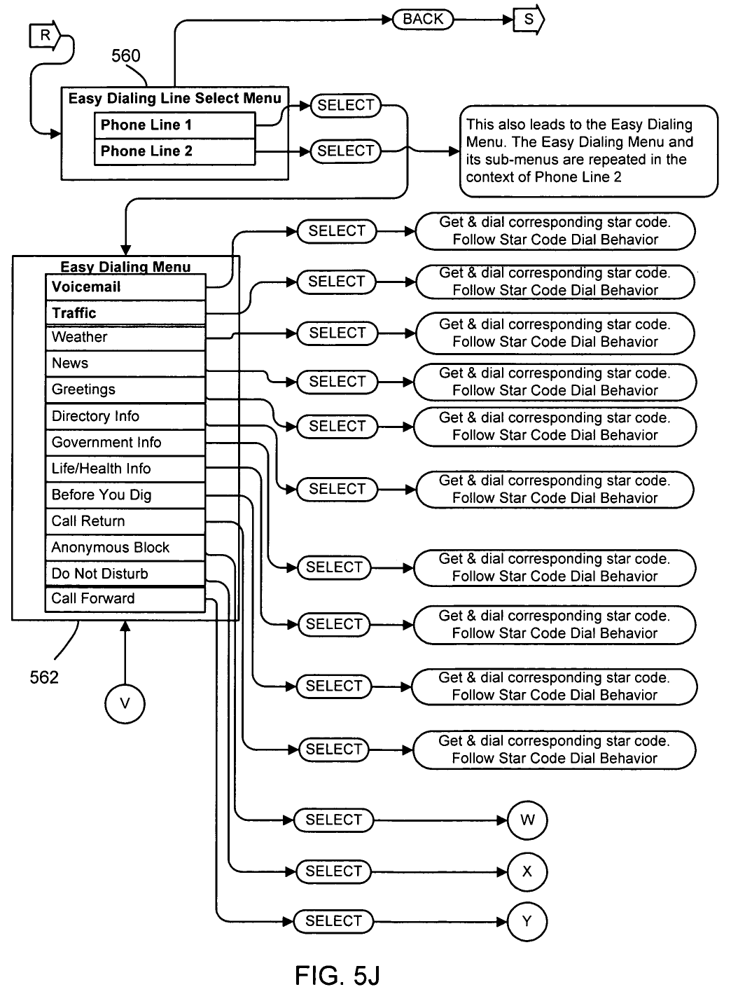

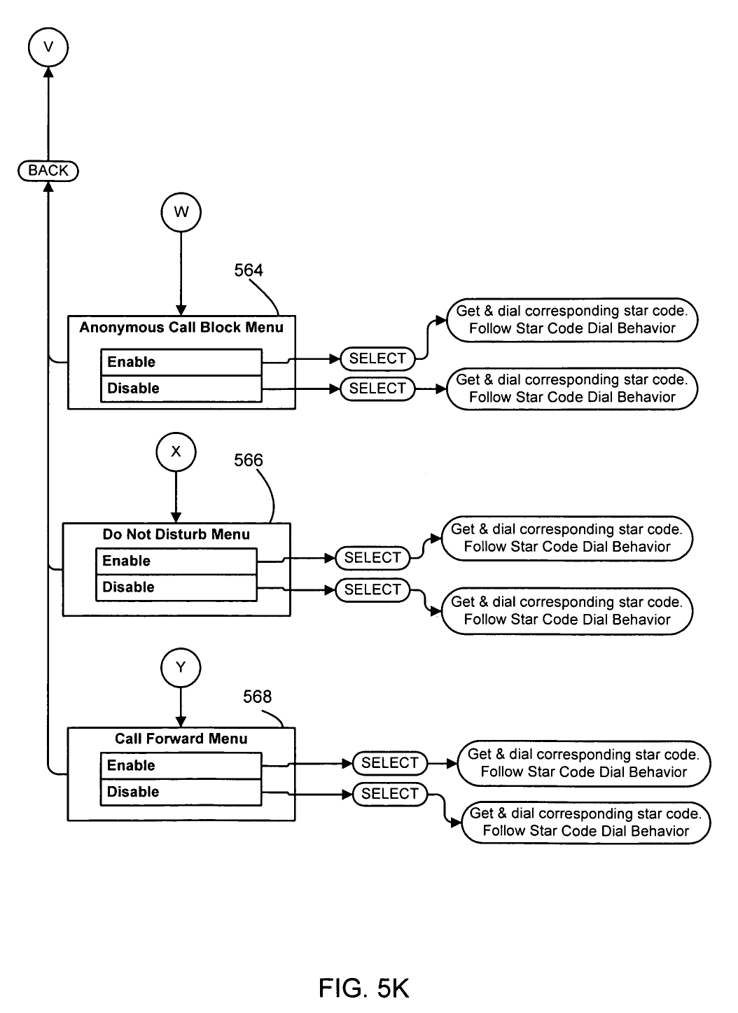

FIGS. 5A-I depict a flowchart 500 of display messages and enhanced information available to the user of the communication service based on various selections available in one embodiment of the invention. Specifically, as a user of the device 100/200/400 interfaces with the display screen 106, various messages will be displayed with various options denoting features, status and other information. Using one or more of the selection buttons 112, the user moves through a menu and received information in accordance with the flowchart 500. Items shown in bold face type in the Figures indicate messages/information that will be displayed by default when the user navigates to that menu level. Items shown in normal type indicate messages/information that will be displayed when the user scrolls to that item. Although numerous menus, paths and selections are provided, the flowchart 500 is in no way limiting or the sole possible layout for navigating through the various menus, submenus and selections and may also include additional features.

For example, after a device has completed its power up and established a connection to the VoIP service provider, the Main Menu 502 appears in the display screen 106 wherein a Call Logs selection and Easy Dialing selection are available by default and additional selections selected from the group consisting of a Status selection, a System selection and a Settings selection are alternately viewable.

Selecting the Call Logs selection results in a Call Logs Line Select Menu 518 (FIG. 5C) appearing on the display screen 106 wherein a First Phone Line selection and a Second Phone Line selection are available by default. Selecting the First Phone Line selection results in a Call Logs Menu 520 appearing on the display screen 106 wherein a Missed Calls selection and a Received Calls selection are available by default and a Dialed Calls selection is alternately viewable. Selecting the Missed Calls selection results in a Missed Calls Menu 520A appearing on the display screen 106 wherein caller information from the latest missed call is available by default and caller information from previously missed calls is alternately viewable. Selecting the missed call presently viewable results in a Missed Calls Item Menu 522 appearing on the display screen 106 wherein selections to Dial or Erase the selected item is available by default and an Erase All selection is alternately viewable. Selecting the Dial selection results in a Dial Menu 522A appearing on the display screen 106 wherein call status information is available by default. If the call is placed successfully, the display goes into a Call Display mode 522C alternately displaying the name/number of the called party and the call timer. Selecting the Erase selection results in an Erase Menu 522B appearing on the display screen 106 wherein a confirmation to erase the displayed item is available by default. If the item is erased successfully, the display returns to the Missed Calls Menu 520A. Selecting the Erase All function erases all items in the Missed Calls Menu 520A and returns to the Call Logs Menu 520. Selecting a Back function from the Erase Menu 522B returns to the Missed Call Item Menu 522. Similarly, selecting a Back function from the Missed Call Item Menu 522 returns to the Missed Calls Menu 520A.

Selecting the Second Phone Line selection of the Call Logs Line Select menu 518 results in a Call Logs Menu 520 appearing on the display screen 106 similar to that for the selection of the First Phone Line as described above. Additionally, all other selections and functionality described above with respect to the First Phone Line are available and duplicated for the Second Phone Line in the same manner. Additionally, selecting a Back function from the Call Logs Lines Select Menu 518 returns to the Main Menu 502.

Selecting the Received Calls selection results in a Received Calls Menu 520B (FIG. 5D) appearing on the display screen 106 wherein caller information from the latest received call is available by default and caller information from previously received calls is alternately viewable. Selecting the received call presently viewable results in a Received Calls Item Menu 524A appearing on the display screen 106 wherein selections to Dial or Erase the selected item is available by default and viewing the call timer is alternately viewable. Selecting the Dial selection results in a Dial Menu 524B appearing on the display screen 106 wherein call status information is available by default. If the call is placed successfully, the display goes into a Call Display mode 524D alternately displaying the name/phone number of the called party and an associated call timer. Selecting the Erase selection results in an Erase Menu 524C appearing on the display screen 106 wherein a confirmation to erase the displayed item is available by default. If the item is erased successfully, the display returns to the Received Calls Menu 520B. Selecting the Erase All function erases all items in the Received Calls Menu 520B and returns to the Call Logs Menu 520. Selecting a Back function from the Erase Menu 524C returns to the Received Call Item Menu 524A. Similarly, selecting a Back function from the Received Call Item Menu 524A returns to the Received Calls Menu 520B. Selecting the View Call Timer selection results in a View Timer Menu 524E appearing on the display screen 106 wherein call time information regarding the selected displayed item is available by default. Selecting a Back function from the View Timer Menu 524E returns to the Received Call Item Menu 524A. Finally, selecting a Back function from the Received Calls Menu 520B returns to the Call Logs Menu 520.

Selecting the Dialed Calls selection results in a Dialed Calls Menu 520C (FIG. 5E) appearing on the display screen 106 wherein caller information from the latest dialed call is available by default and caller information from previously dialed calls is alternately viewable. Selecting the dialed call presently viewable results in a Dialed Calls Item Menu 526A appearing on the display screen 106 wherein selections to Dial or Erase the selected item is available by default and viewing the call timer is alternately viewable. Selecting the Dial selection results in a Dial Menu 526B appearing on the display screen 106 wherein call status information is available by default. If the call is placed successfully, the display goes into an idle mode 526D displaying the Phone Line that is in use. Selecting the Erase selection results in an Erase Menu 526C appearing on the display screen 106 wherein a confirmation to erase the displayed item is available by default. If the item is erased successfully, the display returns to the Dialed Calls Menu 520C. Selecting the Erase All function erases all items in the Dialed Calls Menu 520C and returns to the Call Logs Menu 520. Selecting a Back function from the Erase Menu 526C returns to the Dialed Call Item Menu 526A. Similarly, selecting a Back function from the Dialed Call Item Menu 526A returns to the Dialed Calls Menu 520C. Selecting the View Call Timer selection results in a View Timer Menu 526E appearing on the display screen 106 wherein call time information regarding the selected displayed item is available by default. Selecting a Back function from the View Timer Menu 526E returns to the Dialed Call Item Menu 526A. Finally, selecting a Back function from the Dialed Calls Menu 520C returns to the Call Logs Menu 520.

Selecting the Easy Dialing Line Select Menu 560 (FIG. 5I) appearing on the display screen 106 wherein a First Phone Line selection and a Second Phone Line selection are available by default. Selecting the First Phone Line selection results in an Easy Dialing Menu 562 appearing on the display screen 106 wherein a plurality of dialing features are available to the user. In one embodiment of the invention, a Voicemail selection and a Traffic selection are available by default and features selected from the group consisting of Weather, News, Greetings, Directory Information, Government Information, Life/Health Information, Before You Dig, Call Return, Anonymous Block, Do Not Disturb and Call Forward are alternately viewable. Selecting the Voicemail selection results in a star code operation to connect the user to his voicemail service. For example, upon the user selecting Voicemail, the communication device would automatically dial *123 to access voicemail servers associated with the VoIP service. Similarly, selecting any of Traffic, Weather, News, Greetings, Directory Information, Government Information, Life/Health Information, Before You Dig and Call Return, results in a star code operation to connect the user to the appropriate automated service. Selecting any of Anonymous Block, Do Not Disturb and Call Forward results in a corresponding menu 564, 566 and 568 appearing on the display screen 106 wherein selections to Enable and Disable the selected feature are available by default. Execution of Enable and Disable are accomplished by the star code operation as discussed above with respect to the other features. Selecting a Back function from any of Anonymous Block, Do Not Disturb and Call Forward menus returns to the Easy Dialing Menu 562. Similarly, selecting a Back function from the Easy Dialing Menu 562 returns to the Easy Dialing Select Menu 560.

Selecting the Second Phone Line selection of the Easy Dialing Line Select menu 560 results in an Easy Dial Menu 562 appearing on the display screen 106 similar to that for the selection of the First Phone Line as described above. Additionally, all other selections and functionality described above with respect to the First Phone Line are available and duplicated for the Second Phone Line in the same manner. Additionally, selecting a Back function from the Easy Dialing Line Select Menu 560 returns to the Main Menu 502.

Selecting the Status selection results from the Main Menu 502 results in a Status Menu 528 (FIG. 5F) appearing on the display screen 106 wherein a Customer Account selection and a First Phone Line selection are available by default and a Second Phone Line selection is alternately viewable. Selecting the Customer Account selection results in an Account Menu 530 appearing on the display screen 106 wherein an Account Number and corresponding status information are available by default. Depending on the state of the account, one of a number of messages indicating such status appear on the display screen 106. Messages are selected from the group consisting of: an Active message, a Grace message, a Suspended message, a Terminated message and a Cancelled message. Selecting a Back function from the Account Menu 530 returns to the Status Menu 528.

Selecting the First Phone Line selection results in a First Phone Line Menu 532A appearing on the display screen 106 wherein a First Phone Line selection and a Phone Status selection are available by default. Depending on the state of the phone line and network, one of a number of messages indicating such status appear on the display screen 106. Messages are selected from the group consisting of: if the phone is activated, the phone number will appear and if the phone is not activated, a message indicating the phone is not yet set up for use will appear. Selecting a Back function from the First Phone Line Menu 532A returns to the Status Menu 528.

Selecting the Second Phone Line selection of the Status menu 528 results in a Second Phone Line Menu 532B appearing on the display screen 106 similar to that for the selection of the First Phone Line as described above. Additionally, all other selections and functionality described above with respect to the First Phone Line are available and duplicated for the Second Phone Line in the same manner.

Selecting the System selection from the Main Menu 502 results in a System Menu 506 (FIG. 5A) appearing on the display screen 106 wherein a plurality of system information is displayable. In one embodiment of the invention, device information and network information is available by default and a diagnostics selection is alternately viewable. Selecting the Device Info selection from the System Menu 506 results in a Device Menu 536 (FIG. 5G) appearing on the display screen 106 wherein device information is available by default and alternately available. In one embodiment of the invention, device firmware version information is available as a default information choice and Media Access Control (MAC) Address information is alternately viewable. Selecting a Back function from the Device Menu 536 returns to the System Menu 506. Similarly, selecting a Back function from the System Menu 506 returns to the Main Menu 502.

Selecting the Network Information selection from the System Menu 506 results in a Network Information Menu 534 (FIG. 5G) appearing on the display screen 106 wherein network port information is available by default. In one embodiment of the invention, port information is selected from the group consisting of an Internet Port and an Ethernet Port and preferably one of each such ports are available as default information choices. Selecting the Internet Port selection results in an Internet Port Network Information Menu 534A appearing on the display screen 106 wherein the Internet Protocol (IP) Address is available by default and a plurality of other IP related information is alternately viewable. In one embodiment of the invention, IP related information is selected from the group consisting of Subnet Mask information, Default Router information and Domain Name Server (DNS) information. Selecting a Back function from the Internet Port Network Information Menu 534A returns to the Network Info Menu 534. Similarly, selecting a Back function from the Network Info Menu 534 returns to the System Menu 506. Similarly, selecting a Back function from the System Menu 506 returns to the Main Menu 502.

Selecting the Ethernet Port selection of the Network Info Menu 534 results in a Ethernet Port Network Information Menu 534B appearing on the display screen 106 similar to that for the selection of the Internet Port Network Information Menu 534A as described above. Additionally, all other selections and functionality described above with respect to the Internet Port Network Information Menu 534A are available and duplicated for the Ethernet Port Network Information Menu 534B in the same manner.

Selecting the Diagnostics selection from the System Menu 506 results in a Diagnostics Menu 538 (FIG. 5H) appearing on the display screen 106 wherein a plurality of diagnostic test selections are available. In one embodiment of the invention, Bandwidth and Connections tests are available by default and tests selected from the group consisting of Quality, Phone Ports and sending call statistics are alternately viewable. Selecting the Bandwidth selection results in a Bandwidth Test Menu 540 appearing on the display screen 106 wherein a test status message such as, but not limited to “Test Running, Please Wait” is available by default. Upon completion of the test, a Bandwidth Test Result Menu 542 appears on the display screen 106 wherein a test result message such as, but not limited to “Estimated B/W xxxxxkbps, <Quality rating>” is available by default. One skilled in the art will understand that other appropriate wording maybe substituted. Selecting a Back function from the Bandwidth Test Result Menu 542 returns to the Diagnostics Menu 538. Similarly, selecting a Back function from the Diagnostics Menu 538 returns to the System Menu 506.

Selecting the Connection selection results in a Connection Test Menu 544 appearing on the display screen 106 wherein a test status message such as, but not limited to “Test Running, Please Wait” is available by default. Upon completion of the test, a Connection Test Result Menu 546 appears on the display screen 106 wherein a test result message such as, but not limited to “Connectivity is good” (or similar positive response) or “Network error” (or similar negative response) is available by default. One skilled in the art will understand that other appropriate wording maybe substituted. Selecting a Back function from the Connection Test Result Menu 546 returns to the Diagnostics Menu 538. Similarly, selecting a Back function from the Diagnostics Menu 538 returns to the System Menu 506.

Selecting the Quality selection results in a Network Quality Test Menu 548 appearing on the display screen 106 wherein a test status message such as, but not limited to “Test Running, Please Wait” is available by default. Upon completion of the test, a Network Quality Test Result Menu 550 appears on the display screen 106 wherein a test result message such as, but not limited to “Network quality is good/poor” is available by default. One skilled in the art will understand that other appropriate wording maybe substituted. Selecting a Back function from the Network Quality Test Result Menu 550 returns to the Diagnostics Menu 538. Similarly, selecting a Back function from the Diagnostics Menu 538 returns to the System Menu 506.

Selecting the Phone Ports selection results in a Phone Port Test Menu 552 appearing on the display screen 106 wherein a test confirmation message such as, but not limited to, “Run Test?” is displayed by default. If the test is selected, the Phone Port Test Menu displays a second menu message 554 on the display screen 106 wherein a test confirmation status message such as, but not limited to “Test Running, Please Wait” is displayed by default. Upon completion of the test, a Phone Port Test Result Menu 556 appears on the display screen 106 wherein a test result message such as, but not limited to “Passed” is displayed by default. One skilled in the art will understand that other appropriate wording maybe substituted. Selecting a Back function from the Phone Port Test Result Menu 552 returns to the Diagnostics Menu 538. Similarly, selecting a Back function from the Phone Port Test Result Menu 556 returns to the Diagnostics Menu 538. Finally, selecting a Back function from the Diagnostics Menu 538 returns to the System Menu 506.

Selecting the Send Stats selection from the Diagnostics Menu 538 results in a Send Stats Menu 558 (FIG. 5H) appearing on the display screen 106 wherein a message indicating whether diagnostics data has or has not been sent (to the VoIP Service Provider) is displayed by default. Selecting a Back function from the Send Stats Menu 558 returns to the Diagnostics Menu 538. Similarly, selecting a Back function from the System Menu 506 returns to the Main Menu 502.

Selecting the Settings selection results in a Settings Menu 504 appearing on the display screen 106 wherein a plurality of settings are available for selection. In one embodiment of the invention, a Brightness selection and a Language selection are available by default and a Contrast setting, a Volume setting and a Restore Defaults option are alternately available. Selecting the Brightness selection results in a Brightness Menu 512 appearing on the display screen 106 wherein a Normal selection and a Voicemail selection are available by default (FIG. 5B). Selecting the Normal selection results in a Normal Brightness Menu 514A appearing on the display screen 106 wherein an Off selection and a Low selection are available by default and a Medium selection and a High selection is alternately viewable. If there is no voicemail waiting for a user associated with the device, selecting a desired brightness option will turn a backlight of the display screen 106 to the corresponding setting and then return the display screen 106 to the Brightness Menu 512. Selecting the Voicemail selection results in a Voicemail Brightness Menu 514B appearing on the display screen 106 wherein an Off selection and a Low selection are available by default and a Medium selection and a High selection are alternately viewable. If there is a voicemail waiting for a user associated with the device, selecting a desired brightness option will turn a backlight of the display screen 106 to the corresponding setting and then return the display screen 106 to the Brightness Menu 512. Selecting a Back function from the Brightness Menu 512 returns to the Settings Menu 504. Similarly, selecting a Back function from the Settings Menu 504 returns to the Main Menu 502.

Selecting the Language selection of the Settings Menu 504 results in a Language Menu 516 appearing on the display screen 106 wherein an English selection and a Francais (“French”) selection are available by default (FIG. 5B) and an Espanol (“Spanish”) selection is alternately viewable. Selecting the English selection changes all language text in the display screen 106 to English and then returns the display screen 106 to the Settings Menu 504. Similarly, selecting the Francais selection changes all language text in the display screen 106 to French and then returns the display screen 106 to the Settings Menu 504. Similarly, selecting the Espanol selection changes all language text in the display screen 106 to Spanish and then returns the display screen 106 to the Settings Menu 504. Selecting a Back function from the Settings Menu 504 returns to the Main Menu 502.

Selecting the Contrast selection of the Settings Menu results in a Contrast Menu 508 appearing on the display screen 106 wherein function keys and a display contrast level meter are available by default. Selecting the desired arrow key (i.e., up or down) on the communication device results in movement of the contrast level meter on the display screen 106. Selecting the new contrast level, applies and saves such new contrast level to the display. Selecting a Back function from the Contrast Menu 508 returns to the Settings Menu 504. Similarly, selecting a Back function from the Settings Menu 504 returns to the Main Menu 502.

Selecting the Volume selection of the Settings Menu results in a Volume Menu 510 appearing on the display screen 106 wherein function keys and a volume adjustment level meter are available by default. Selecting the desired arrow key (i.e., up or down) on the communication device results in movement of the volume adjustment level meter on the display screen 106. Selecting the new volume level, applies and saves such new volume level to the display. Selecting a Back function from the Volume Menu 510 returns to the Settings Menu 504. Similarly, selecting a Back function from the Settings Menu 504 returns to the Main Menu 502.

Selecting the Restore Defaults of the Settings Menu results in a Reset confirmation request 511 appearing on the display screen 106. Selecting the Reset Request results in restoration of the default communication device settings and returning to the Settings Menu 504. Similarly, selecting a Back function from the Settings Menu 504 returns to the Main Menu 502 but without affecting any settings changes.

Selecting the Test Bandwidth selection from the System Menu 506 results in a Bandwidth Test Menu 508 (FIG. 5A) appearing on the display screen 106 wherein an option to test bandwidth and a completion indicator of such test is available by default. Selecting a Back function from the Bandwidth Test Menu 508 returns to the System Menu 506. Similarly, selecting a Back function from the System Menu 506 returns to the Main Menu 502.

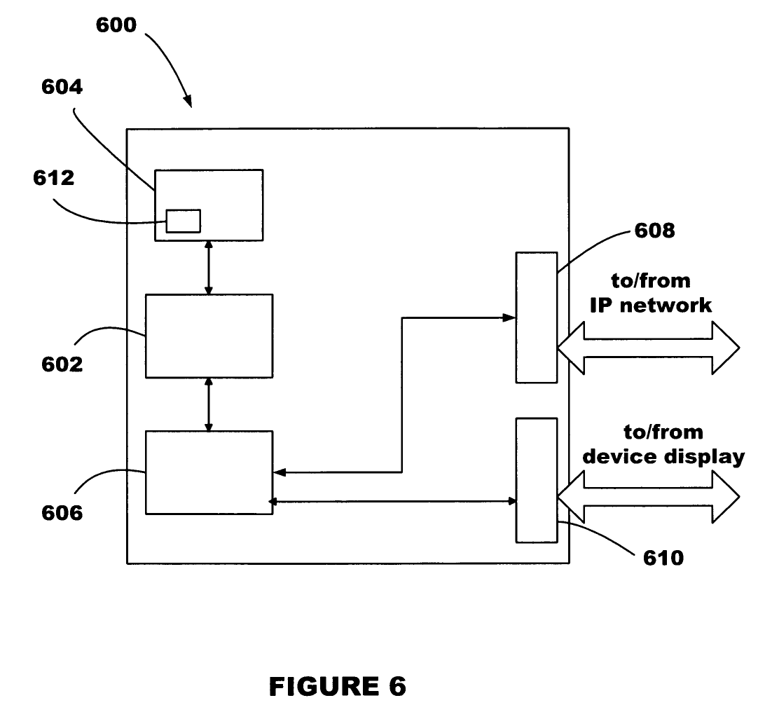

FIG. 6 depicts a schematic diagram of a controller 600 that may be used to practice the present invention of displaying enhanced information as described above. The controller 600 may be one of any form of a general purpose computer processor used in computing functions including but not limited to accessing an IP-based network such as a corporate intranet, the Internet or the like. The controller 600 comprises a central processing unit (CPU) 602, a memory 604, and support circuits 606 for the CPU 602. The controller 600 also includes provisions 608/610 for connecting the communication device 100/200/400 to a telecommunications service provider (via a packet based, i.e., IP, network) and to one or more input/output devices such as but not limited to the display screen 106 and function buttons 112 described above. Note that the provisions 608/610 are shown as separate bus structures in FIG. 6; however, they may alternately be a single bus structure without degrading or otherwise changing the intended operability of the controller 600 or invention in general.

The memory 604 is coupled to the CPU 602. The memory 604, or computer-readable medium, may be one or more of readily available memory such as random access memory (RAM), read only memory (ROM), floppy disk, hard disk, flash memory or any other form of digital storage, local or remote. The support circuits 606 are coupled to the CPU 602 for supporting the processor in a conventional manner. These circuits include cache, power supplies, clock circuits, input/output circuitry and subsystems, and the like. A software routine 612, when executed by the CPU 602, causes the controller 600 to perform processes of the present invention and is generally stored in the memory 604. The software routine 612 may also be stored and/or executed by a second CPU (not shown) that is remotely located from the hardware being controlled by the CPU 602.

The software routine 612 is executed when a preferred method of enhanced messaging in accordance with the subject invention is desired. The software routine 612, when executed by the CPU 602, transforms the general purpose computer into a specific purpose computer (controller) 600 that controls interaction between the communication device and the service provider and other similar actions. Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 612 of the present invention is capable of being executed on computer operating systems including but not limited to Microsoft Windows 98, Microsoft Windows XP, Apple OS X, Linux and eCos. Similarly, the software routine 612 of the present invention is capable of being performed using CPU architectures including but not limited to Apple Power PC, Intel x86, Sun service provider agentRC, Intel ARM and MIPS.

In one embodiment of the invention, enhanced information is conveyed to the communication device from the service provider. Conveyance of the enhanced information is executed by one selected from the group consisting of the information being embedded in a device profile that is downloaded to the communication device and the information being embedded in a SIP NOTIFY message. Those skilled in the art of packet-based communication systems are familiar with the Session Initial Protocol (SIP) and the various messages including NOTIFY and such information has been referenced earlier in the specification. Once the enhanced information is conveyed, a portion or one or more software routines 612 performs the necessary steps to display the enhanced information on the display 106. For example, the communication device may request the information (in the form of an updated device profile) or be given the information upon expiration of a polling period, power up condition or as part of a NOTIFY message. The information is then temporarily stored (i.e., in memory 604 while processing occurs to prepare the information for display.

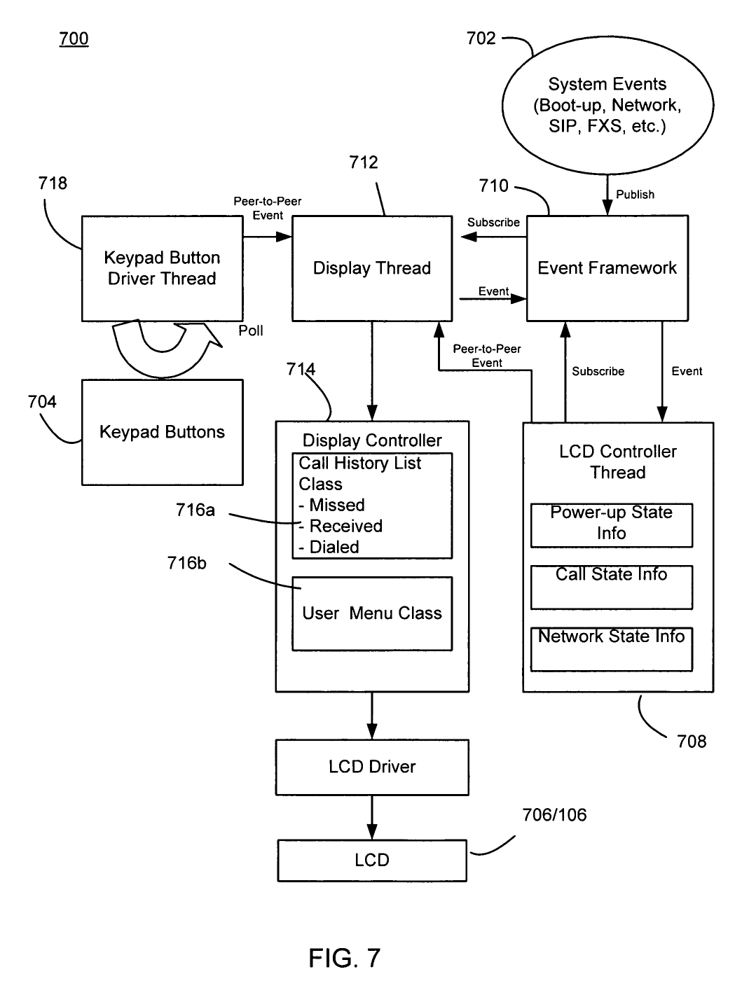

FIG. 7 depicts a representational architecture 700 of software and related functions in the subject invention. Such architecture 700 includes gathering relevant system events 702 and printing appropriate messages on the LCD screen 706/106 via various event frameworks, threads, controllers and drivers as depicted. Events 702 may include boot-up (including the above-presented downloading of the device profile), network, SIP call control or FXS events. The architecture 700 also monitors keypad button events (generated by keypad buttons 704 and brings up a user menu on the LCD screen 706/106 in response to the keypad button events.

An LCD Controller thread 708 subscribes to specific events from an Event Framework 710 and maintains state information for Power-up states, Network states and Call states. It provides notification of state changes after appropriate filtering to a Display Thread 712. Based on the state, the Display Thread 712 calls the corresponding method within Display Controller classes 716 in a Display Controller 714 to display appropriate messages. The Display Thread 712 accepts event notification from the LCD Controller thread 708, a Keypad Driver Thread 718 and some events from the Event Framework 710. It calls the corresponding method within the Display Controller classes 716 to provide the event enumerations, which the Display Controller 714 uses to display appropriate messages on the LCD 706/106.

The Display Controller 714 runs in the context of the Display Thread 712. It accepts filtered events from the Display Thread 712. The Display Controller 714 also implements the User Menu Classes 716b and the Call History Classes 716a. When a keypad event is received, it results in state transitions in the User Menu Classes 716b and display of the appropriate menu. When a call state event is received (for example incoming call with a calling party identifier), the Display Controller 714 displays the corresponding message on the LCD 706/106 (in this case, the Caller ID). The Display Controller 714 also manages the icons. Since the ownership of the LCD 706/106 is always with the Display Controller 714, it prioritizes display of error messages over menu or informational messages. It may also block certain messages if it is displaying critical error messages.

In particular, the priority scheme and corresponding behavior implemented by the Display Controller 714 is as follows:

After all the power up messages from the LCD Controller, it displays the Default message (from a downloaded device profile).

In case of an Error message from the LCD, it displays the error message indefinitely. It also slowly blinks the backlight between low and high intensity in this condition.

If the user navigates into the user menu when an Error message is being displayed, the backlight changes to the intensity that was selected by the user (or the default intensity if it was after power up). When the user exits the user menu, it displays the Error message again (with the backlight blinking) if the error condition is persisting. If the error condition has cleared up, then it displays the Default message with the backlight at the intensity that was selected by the user (or the default intensity if it was after power up).

Warning or informational messages (such as Caller ID) will be displayed for some time (˜10 secs), and then the Default Message is displayed.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. A method for information conveyance in an end user device of a packet-based communication service, the end user device connected to a PSTN-based communication device, the method comprising:
detecting a power up condition of the end user device connected to the PSTN-based communication device;
detecting a packet-based network connection;
retrieving an end user profile from the packet-based communication service;
attempting a communication registration operation; and
displaying one or more non-binary type messages at the end user device regarding the status of the communication service.

2. The method of claim 1 wherein the end user profile contains IP configuration information.

3. The method of claim 1 where the registration operation is performed via SIP.

4. The method of claim 1 where the one or more messages is provided in the end user profile or delivered via a SIP NOTIFY message.

5. A method for information conveyance in an end user device of a packet-based communication service, the end user device connected to a PSTN-based communication device, the method comprising:
displaying one or more non-binary type messages at the end user device regarding the status of the communication service, the one or more messages selected from the group consisting of:
detecting a power up condition of the end user device connected to the PSTN-based communication device;
detecting a packet-based network connection;
retrieving an end user profile from the packet-based communication service; and
attempting a communication registration operation.

6. The method of claim 5 wherein the end user profile contains IP configuration information.

7. The method of claim 5 where the registration operation is performed via SIP.

8. The method of claim 5 where the one or more messages is provided in the end user profile or delivered via a SIP NOTIFY message.

9. Apparatus for enhanced information conveyance for end users of a packet-based communication service comprising:
a main body having at least one local area packet network connection means, at least one wide area packet network connection means and at least one non-packet network connection means for connection of a PSTN-based communication device;
a display panel body adapted to display information regarding the status of the communication service in a non-binary manner.

10. The apparatus of claim 9 wherein the display panel adaptation further comprises enhanced information conveyance means selected from the group consisting of a display screen, one or more function buttons and a combination of members of said group.

11. The apparatus of claim 9 further comprising articulation means between the main body and display panel body for providing freedom of movement between the main body and display panel body.

12. The apparatus of claim 11 where the articulation means is selected from the group consisting of a hinge assembly, a set of telescoping members, a gimbal assembly and wireless means.

13. The apparatus of claim 9 wherein the display panel body enhanced information conveyance means is responsive to communication service status messages from the packet-based communication service.

14. The apparatus of claim 13 wherein the status messages are selected from the group consisting of messages included in the end user profile and messages provided by SIP messaging.

15. The apparatus of claim 9 wherein the display panel body enhanced information conveyance means is responsive to user-based requests to the packet-based communication service.

16. The apparatus of claim 15 wherein the user-based requests are selected from the group consisting of changing system features or apparatus settings associated with the end user device, reviewing call logs associated with the end user device, reviewing a status of user communication channels, inquiring about general system information and initiating user-based diagnostics for troubleshooting.

17. The apparatus of claim 9 wherein the main body and the display panel body are integral with each other.
